(19) United States
(12) Patent Application Publication
(10) Pub. No.: US 2020/0141526 A1
(43) Pub. Date: May 7, 2020

(54) SWIVEL JOINT

(71) Applicant: Caterpillar Inc., Deerfield, IL (US)

(72) Inventors: Brian G. Tyler, Trevor, WI (US); Zachary A. Schramm, Antioch, IL (US)

(73) Assignee: Caterpillar Inc., Deerfield, IL (US)

(21) Appl. No.: 16/178,708

(22) Filed: Nov. 2, 2018

(51) Int. Cl. F16L 27/08; F16C 33/78; F16C 19/36

(52) U.S. Cl. CPC F16L 27/0824; F16C 19/361; F16C 33/7896; F16C 33/7809

(57) ABSTRACT

A linear roller bearing includes a cylindrical body defining a cylindrical axis and a diameter. The cylindrical body defines a cylindrical body axial length, and a ratio of the diameter to the cylindrical body axial length ranges from 0.75 to 1.1.

### TECHNICAL FIELD

The present disclosure relates to swivel joints used to connect pipes in the oil and gas industry, and the like. Specifically, the present disclosure relates to a swivel joint employing roller bearings.

### BACKGROUND

Piping often requires that the lengths of piping (may also be referred to as conduits) be connected to each other. This sometimes involves connecting long lengths of pipe with free ends that are fixed relative to each other both rotationally and longitudinally. A swivel joint may be provided with components capable of connecting to the free ends of the pipe since the components of the swivel joint are free to rotate relative to each other, allowing the components to be threaded onto at least one free end of the pipe.

Also, the lengths of pipe may vibrate. Providing a swivel joint may help to dampen the vibrations and help to maintain the integrity of the joint by helping the joint stay sound structurally and while also limiting the risk of leaks.

Some swivel joints use various types of bearings to allow the components of the swivel joint to rotate relative to each other. Over time, the bearings may become worn or may “washout”. “Washout” is a phenomenon that occurs when oil, gas, or other fluid being conveyed through the pipes and the swivel joint infiltrates the bearings and removes any lubricant, decreasing the effective life of the bearings.

U.S. Pat. Application Publication No. 2006/0131873A1 to Klingbail et al. discloses a high-pressure swivel joint which can be used to connect two conduits rotatably. The swivel joint includes an inner conduit and outer conduit, which are secured together by means of linear roller bearings. Elastomeric packing is provided to prevent fluid from entering the bearings. This swivel joint is described as allowing high velocity fluid transfers and also for sour gas services at high pressures (see the Abstract of Klingbail et al.).

However, continuous improvement of swivel joints is warranted to maximize the robustness and the longevity of the swivel joint.

### SUMMARY

A swivel joint assembly according to an embodiment of the present disclosure may comprise a first coupling member including a first end and a second end, and a second coupling member including a third end and a fourth end. The third end of the second coupling member may include a sleeve portion, and the second end of the first coupling member may include an insertion portion. The insertion portion may define a radial direction, a longitudinal axis, and a circumferential direction. The insertion portion may further define a first bearing receiving slot further defining a first radial depth and a first longitudinal width. A ratio of the first radial depth to the first longitudinal width may range from 0.35 to 0.7.

A coupling member according to an embodiment of the present disclosure may comprise an annular body defining a circumferential direction, a radial direction and a longitudinal axis. The annular body may include a proximate end and a distal end. The proximate end may define a bearing receiving slot defining a radial slot dimension and an axial slot width. A ratio of the radial slot dimension to the axial slot width may range from 0.3 to 0.8

A linear roller bearing according to an embodiment of the present disclosure may comprise a cylindrical body defining a cylindrical axis and a diameter. The cylindrical body may define a cylindrical body axial length, and a ratio of the diameter to the cylindrical body axial length may range from 0.75 to 1.1.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a perspective view of a swivel joint assembly according to an embodiment of the present disclosure utilizing two sets of linear roller bearings.

FIG. 2 is a front view of the swivel joint assembly of FIG. 1.

FIG. 3 is a sectional view of the swivel joint assembly of FIG. 2 taken along lines 3-3 thereof.

FIG. 4 is a perspective view of the externally threaded coupling member of the swivel joint assembly of FIG. 1, shown in isolation from the swivel joint assembly.

FIG. 5 is a front view of the externally threaded coupling member of the FIG. 4.

FIG. 6 is a sectional view of the externally threaded coupling member of FIG. 5 taken along lines 6-6 thereof.

FIG. 7 is an enlarged detail view of the roller bearing receiving slots of the externally threaded coupling member of FIG. 6.

FIG. 8 is an enlarged detail view of one of the roller bearing receiving slots of FIG. 7, showing the features of the roller bearing receiving slot more clearly.

FIG. 9 is a perspective view of a swivel joint assembly according to another embodiment of the present disclosure utilizing a single set of linear roller bearings.

FIG. 10 is an exploded assembly view of the swivel joint assembly of FIG. 9.

FIG. 11 is a sectional view of the swivel joint assembly of FIG. 9 with the collar member removed for enhanced clarity.

FIG. 12 is a perspective view of the externally threaded coupling member of the swivel joint assembly of FIG. 9, shown in isolation from the swivel joint assembly.

FIG. 13 is a front view of the externally threaded coupling member of the FIG. 12.

FIG. 14 is a sectional view of the externally threaded coupling member of FIG. 13 taken along lines 14-14 thereof.

FIG. 15 is an enlarged detail view of the roller bearing receiving slot of the externally threaded coupling member of FIG. 14.

FIG. 16 is an enlarged detail view of the roller bearing receiving slot of FIG. 15, showing the features of the roller bearing receiving slot more clearly.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of a swivel joint assembly, a coupling member with a roller bearing receiving slot, and a linear roller bearing according to the present disclosure will now be described. In some embodiments, the material used to construct the coupling member and/or the linear roller bearing may be selected to help improve the durability or longevity of the swivel joint assembly.

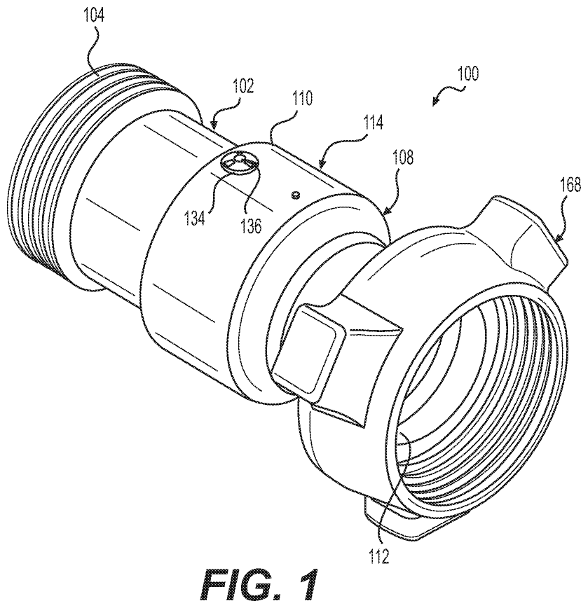

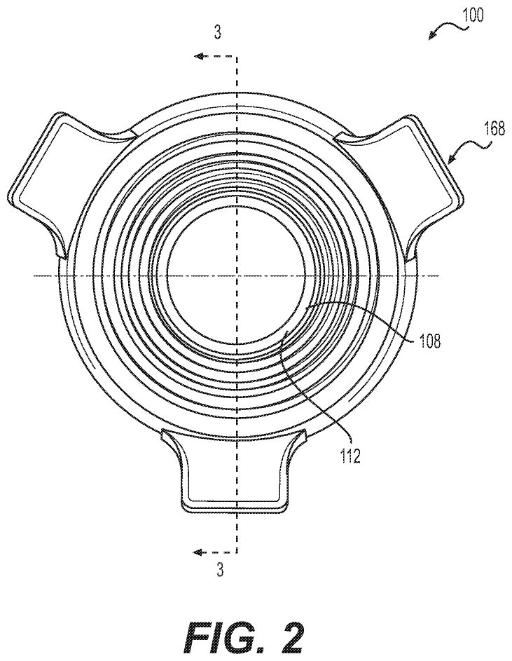

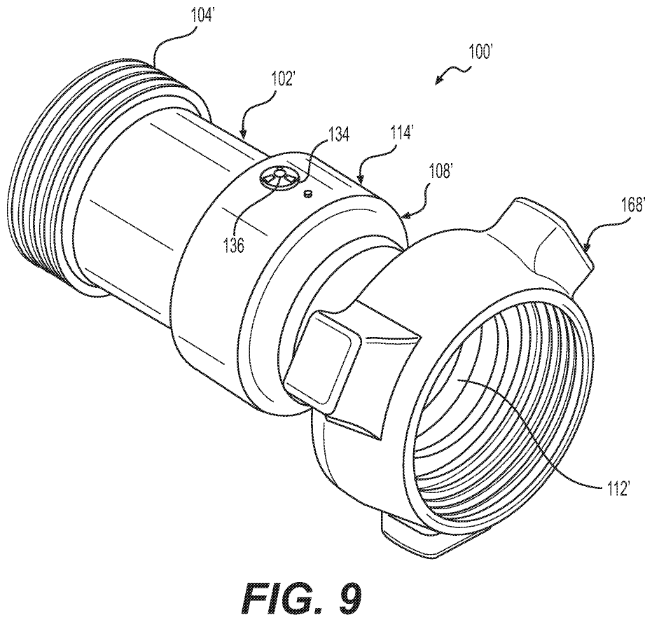

Looking at FIGS. 1 thru 4 and 9 thru 12, a swivel joint assembly 100 according to an embodiment of the present disclosure using two sets of linear roller bearings 300 (FIGS. 1 thru 4, reference numerals lack a prime) and swivel joint assembly 100′ using a single set of linear roller bearings 300 (FIGS. 9 thru 12, reference numerals may have a prime) may be described as follows. Each assembly 100, 100′ may comprise a first coupling member 102, 102′ including a first end 104, 104′ and a second end 106, 106′ and a second coupling member 108, 108′ including a third end 110, 110′ and a fourth end 112, 112′. The third end 110, 110′ of the second coupling member 108, 108′ may include a sleeve portion 114, 114′ while the second end 106, 106′ of the first coupling member 102, 102′ may include an insertion portion 116, 116. A collar member 168, 168′ may also be provided.

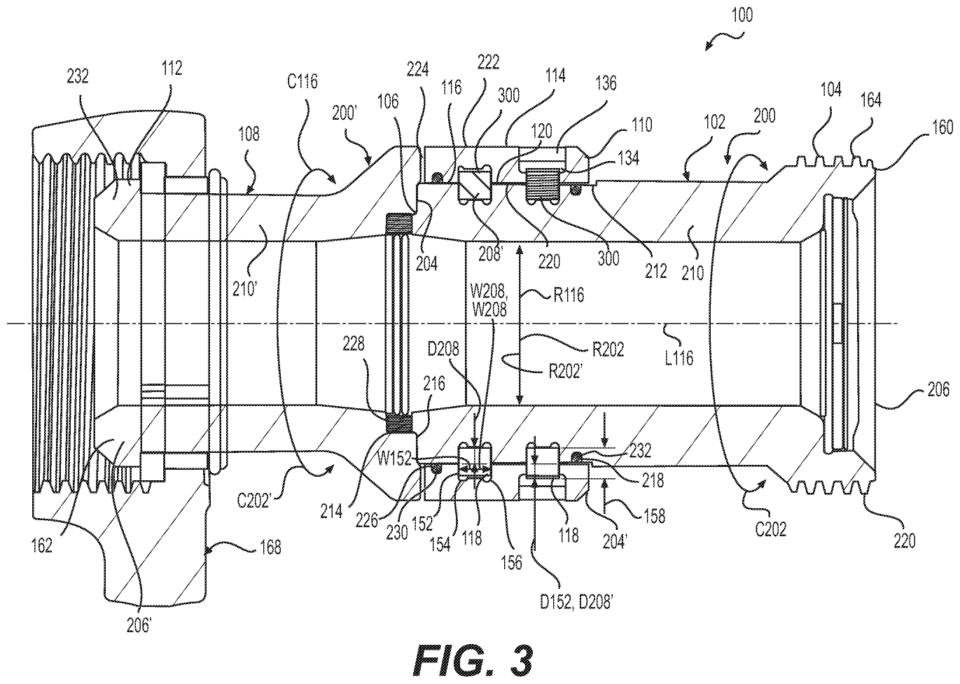

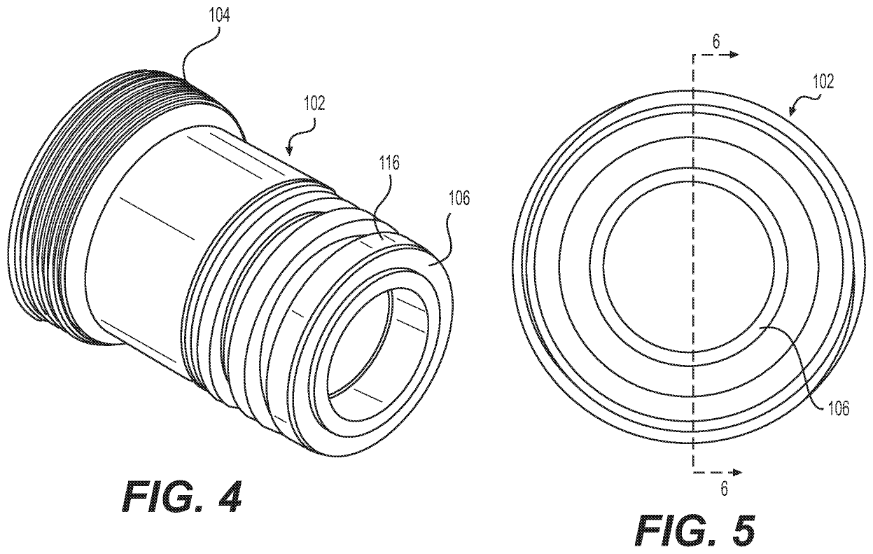

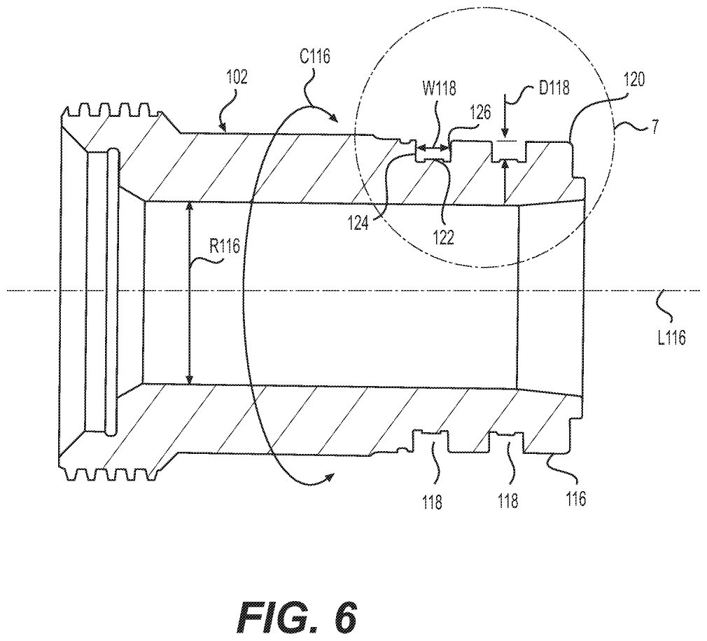

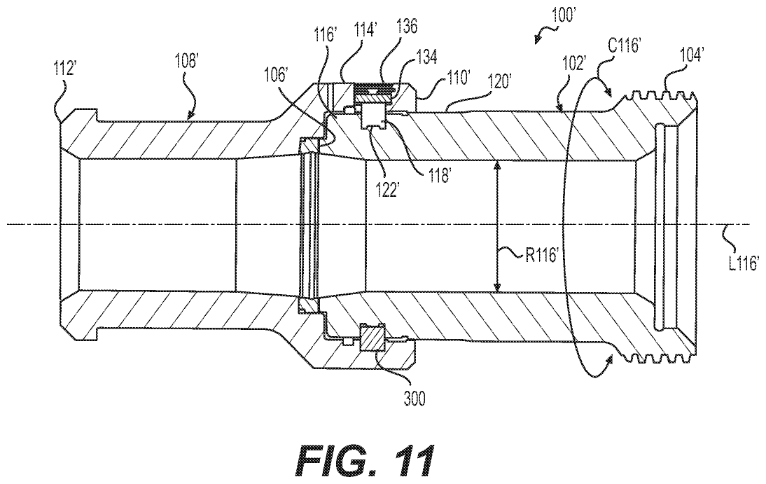

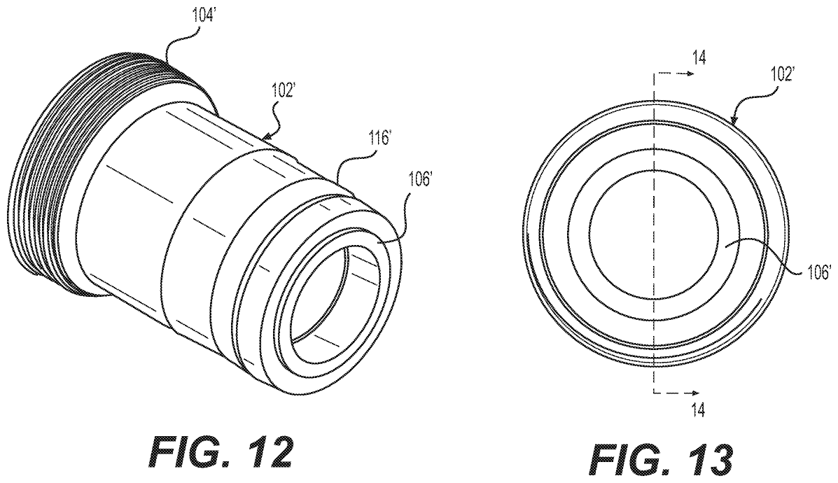

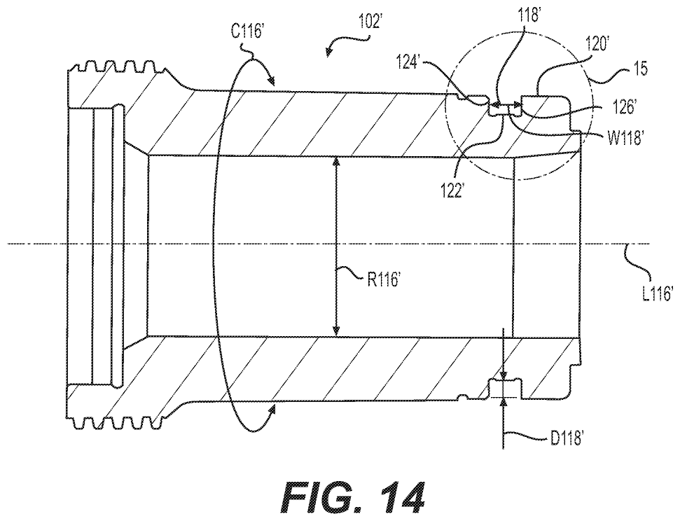

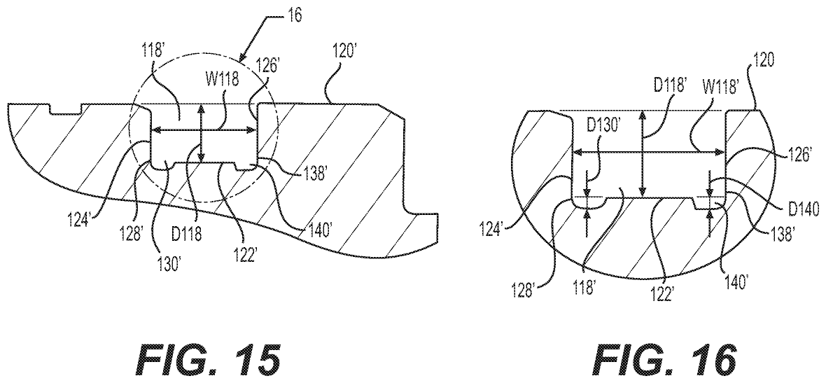

As best seen in FIGS. 3 and 6 thru 8 for assembly 100 and FIGS. 11 and 14 thru 16 for assembly 100′, the insertion portion 116, 116′ may define a radial direction R116, R116′, a longitudinal axis L116, L116′, and a circumferential direction C116, C116′. The insertion portion 116, 116′ may further define a first bearing receiving slot 118, 118′ further defining a first radial depth D118, D118′ and a first longitudinal width W118, W118′. A ratio of the first radial depth D118, D118′ to the first longitudinal width W118, W118′ may range from 0.35 to 0.7, and may be approximately 0.57 in certain embodiments.

Furthermore, the insertion portion 116, 116′ may define an outer circumferential surface 120, 120′, and an inner radial bearing support surface 122, 122′. The first radial depth D118, D118′ may be measured along the radial direction R116, R116′ from outer circumferential surface 120, 120′ to the inner radial bearing support surface 122, 122′.

Likewise, the insertion portion 116, 116′ may define a first side bearing support surface 124, 124′ and a second side bearing support surface 126, 126′. The first longitudinal width W118, W118′ may be measured along the longitudinal axis L116, L116′ from the first side bearing support surface 124, 124′ to the second side bearing support surface 126, 126′.

The first side bearing support surface 124, 124′ may form a first theoretical sharp corner 128, 128′ with the inner radial bearing support surface 122, 122′. The insertion portion 116, 116′ may also define a first relief cutout 130 extending radially below the first theoretical sharp corner 128, 128′ a first radial distance D130, D130′. The first relief cutout 130, 130′ may avoid corner interference with a bearing 300 placed in the first bearing receiving slot 118, 118′ and may allow lubricant to be distributed within the first bearing receiving slot 118, 118′.

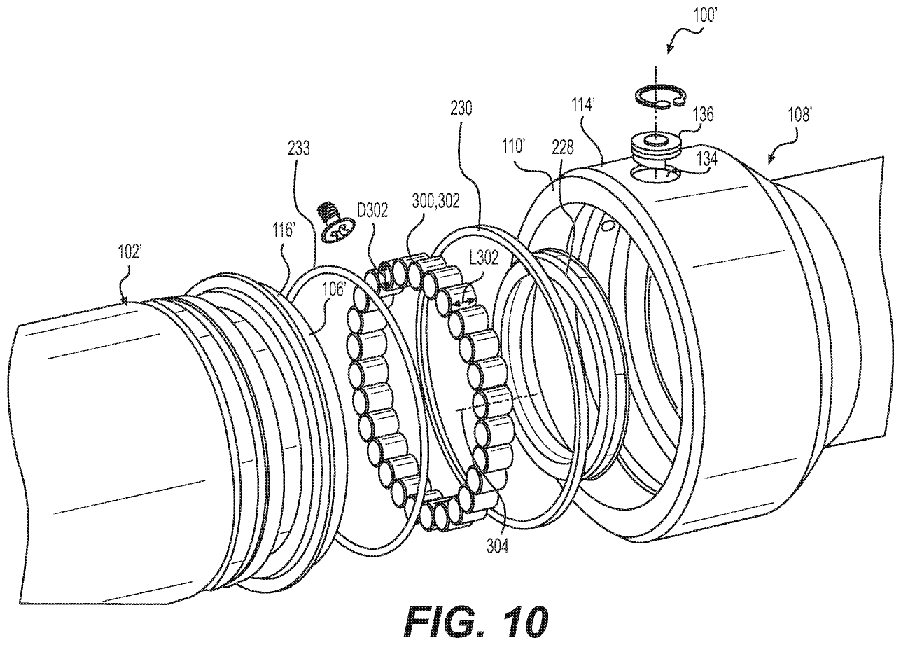

As best seen in FIG. 10, a plurality of bearings 300 may be provided that are in close proximity to each other in the first bearing slot 118, 118′. An access port 134 and plug 136 are provided so that the bearings 300 can be inserted into the first bearing receiving slot 118, 118′.

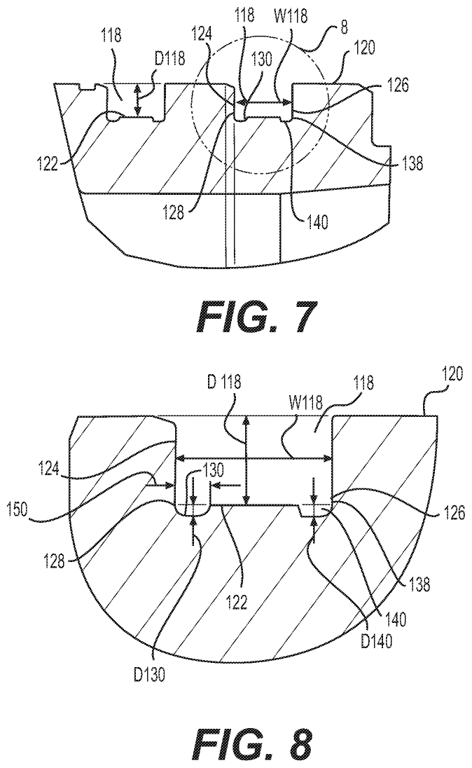

Looking at FIGS. 7 and 8, the second side bearing support surface 126, 126′ may form a second theoretical sharp corner 138, 138′ with the inner radial bearing support surface 122, 122′. The insertion portion 116, 116′ may define a second relief cutout 140, 140′ extending radially below the second theoretical sharp corner 130, 130′ a second radial distance D140, D140′.

The first relief cutout 130 and the second relief cutout 140 may be identically configured, but this may not be the case in other embodiments. When identically configured, the first radial distance D130 matches the second radial distance D140. Both the first radial distance D130 and the second radial distance D140 may range from 0.005 of an inch to 0.100 of an inch, Also, the first relief cutout 130 and the second relief cutout 140 may also define the same longitudinal cutout dimension 150, which may range from 0.03 of an inch to 0.15 of an inch. Any of these dimensions and ratios discussed herein may be varied as needed or desired in other embodiments.

Focusing on FIG. 3, the sleeve portion 114 of the second coupling member 108 may define a second bearing receiving slot 152, defining a second longitudinal width W152. This width W152 may be equal to (+/−0.010″) or greater than the first longitudinal width W118. The second bearing receiving slot may also define a second radial depth D152 that is equal to (+/−0.010″) or less than the first radial depth D118.

With continued reference to FIG. 3, the sleeve portion 114 may define a third relief cutout 154 and a fourth relief cutout 156, both of which may be identically configured as the first relief cutout 130 and the second relief cutout 140. The first bearing receiving slot 118 and the second bearing receiving slot 152 may be axially aligned with each other so that they can receive and hold the bearings 300 as previously alluded to herein. This alignment may define an overall radial dimension 158, and a ratio of the overall radial dimension 158 to the first longitudinal width W118 may range from 0.75 to 1.1.

As shown in FIG. 3, the first end 104 of the first coupling member 102 may be a first attachment end 160 (i.e. used to be attached to a conduit or pipe) and the fourth end 112 of the second coupling member 108 may be a second attachment end 162. The first attachment end 160 may be externally threaded 164 and the second attachment end 162 may be flanged 166.

With continued reference to FIG. 3, a coupling member 200, 200′ according to an embodiment of the present disclosure will be discussed. The coupling member 200, 200′ may comprise an annular body 202, 202′ defining a circumferential direction C202, C202′, a radial direction 8202, 8202′ and a longitudinal axis L202, L202′. The annular body 202, 202′ may include a proximate end 204, 204′ and a distal end 206, 206′. The proximate end 204, 204′ may define a bearing receiving slot 208, 208′ defining a radial slot dimension D208, D208′ and an axial slot width W208, W208′. A ratio of the radial slot dimension D208, D208′ to the axial slot width W208, W208′ may range from 0.3 to 0.8.

For the embodiments shown in FIG. 3, the annular body 202, 202′ is straight, forming cylindrical walls 210, 210′ that extend from the proximate end 204, 204′ to the distal end 206, 206′. In other embodiments, a curved coupling member may be provided (e.g. a right angle elbow). The proximate end 204, includes an insertion portion 116 defining the bearing receiving slot 208, a radial external surface 212, an axial external surface 214, a corner 216 defined by the radial external surface 212 and the axial external surface 214, and a seal receiving slot 218 disposed axially between the bearing receiving slot 208 and the distal end 206. The distal end 206 may include external threads 220. A dust seal 233 may be disposed in the seal receiving slot 218 to help keep debris, dirt, dust, etc. from infiltrating the bearings. Other configurations are possible.

For example, the coupling member 200′ may have a proximate end 204′ that includes a sleeve portion 114 defining an internal circumferential surface 220 and an external circumferential surface 222. The sleeve portion 114 further defining a channel 224 extending from the internal circumferential surface 220 to the external circumferential surface 222. This channel 224 may allow fluid to escape if the end seal 228 leaks, alerting the user that maintenance is warranted. The internal circumferential surface 220 may define a seal receiving groove 226 that is disposed axially between the channel 224 and the bearing receiving slot 208′. A ring seal 230 such as an O-ring or may be placed in the this seal receiving groove 226 to help prevent fluid from infiltrating the bearings should the end seal 228 leak, helping to prevent “wash out”. The distal end 206′ may include a flange 232.

The coupling member 200, 200′ may be fabricated from any suitable material and may be coated to prolong its useful life. In particular, the annular body 202, 202′ may be made from steel, iron, specific example, etc. and the internal surfaces may be coated with tungsten carbide, etc.

A linear roller bearing 300 may be provided as best seen in FIGS. 3, 10 and 11. As best seen in FIG. 10, the linear roller bearing 300 may comprise a cylindrical body 302 defining a cylindrical axis 304 and a diameter D302. The cylindrical body 302 defines cylindrical body axial length L302, and a ratio of the diameter D302 to the cylindrical body axial length L302 may range from 0.75 to 1.1 in particular embodiments. The diameter D302 may range from 0.250 of an inch to 0.750 of an inch and the cylindrical body axial length L302 may range from 0.225 of an inch to 1.0 inch in particular embodiments. Furthermore, the linear roller bearing may be made of steel such as AISI 52100 and cylindrical body 302 may be at least partially coated with tungsten carbide.

It is to be understood that the size of any bearing and any associated bearing slot configured to receive that bearing may be sized so that a slight clearance is provided between the bearing and the slot so that the bearings can rotate therein freely and the swivel joint can also rotate freely.

Any of the configurations, materials, material properties, coatings, ratios and dimensions mentioned herein may be altered in various embodiments of the present disclosure to have different values or characteristics than what has been specifically mentioned herein or shown in the drawings.

### INDUSTRIAL APPLICABILITY

In practice, a swivel joint assembly, a coupling, and/or a linear roller bearing according to any embodiment described herein may be sold, bought, manufactured or otherwise obtained in an OEM (original equipment manufacturer) or after-market context.

The various dimensions, ratios, materials, material properties, and/or coatings may help to increase the useful life of the swivel joint in various applications under various operation conditions. Suitable applications includes those conveying any type of fluid through conduits and the swivel joint as well as an type of lubricant being used with the linear roller bearings.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A swivel joint assembly comprising:
a first coupling member including a first end and a second end; and
a second coupling member including a third end and a fourth end;
wherein the third end of the second coupling member includes a sleeve portion, the second end of the first coupling member includes an insertion portion, the insertion portion defining
a radial direction, a longitudinal axis, and a circumferential direction;
a first bearing receiving slot further defining a first radial depth and a first longitudinal width, and a ratio of the first radial depth to the first longitudinal width ranges from 0.35 to 0.7.

2. The swivel joint assembly of claim 1 wherein insertion portion defines an outer circumferential surface, and an inner radial bearing support surface, and the first radial depth is measured along the radial direction from outer circumferential surface to the inner radial bearing support surface.

3. The swivel joint assembly of claim 2 wherein the insertion portion defines a first side bearing support surface, a second side bearing support surface, and the first longitudinal width is measured along the longitudinal axis from the first side bearing support surface to the second side bearing support surface.

4. The swivel joint assembly of claim 3 wherein the first side bearing support surface forms a first theoretical sharp corner with the inner radial bearing support surface, and the insertion portion defines a first relief cutout extending radially below the first theoretical sharp corner a first radial distance.

5. The swivel joint assembly of claim 4 wherein the second side bearing support surface forms a second theoretical sharp corner with the inner radial bearing support surface, and the insertion portion defines a second relief cutout extending radially below the second theoretical sharp corner a second radial distance.

6. The swivel joint assembly of claim 5 wherein the first relief cutout and the second relief cutout are identically configured, defining a first radial distance matching the second radial distance, both the first radial distance and the second radial distance ranging from 0.005 of an inch to 0.1 of an inch, the first relief cutout and the second relief cutout also defining the same longitudinal cutout dimension ranging from 0.005 of an inch to 0.1 of an inch.

7. The swivel joint assembly of claim 6 wherein the sleeve portion of the second coupling member defines a second bearing receiving slot defining a second longitudinal width equal to or greater than the first longitudinal width and a second radial depth that is equal to or less than the first radial depth.

8. The swivel joint assembly of claim 7 wherein the sleeve portion defines a third relief cutout and a fourth relief cutout identically configured as the first relief cutout and the second relief cutout and the first bearing receiving slot and the second bearing receiving slot are axially aligned with each other, defining an overall radial dimension, and a ratio of the overall radial dimension to the first longitudinal width ranges from 0.75 to 1.1.

9. The swivel joint assembly of claim 1 wherein the first end is a first attachment end and the fourth end is a second attachment end.

10. The swivel joint assembly of claim 9 wherein the first attachment end is externally threaded and the second attachment end is flanged.

11. A coupling member comprising:
an annular body defining a circumferential direction, a radial direction and a longitudinal axis, the annular body including
a proximate end and a distal end; wherein
the proximate end defines a bearing receiving slot defining a radial slot dimension and an axial slot width, and a ratio of the radial slot dimension to the axial slot width ranges from 0.35 to 0.7.

12. The coupling member of claim 11 wherein the annular body is straight, forming cylindrical walls that extend from the proximate end to the distal end.

13. The coupling member of claim 11 wherein the proximate end includes an insertion portion defining the bearing receiving slot, a radial external surface, an axial external surface, a corner defined by the radial external surface and the axial external surface, and a seal receiving slot disposed axially between the bearing receiving slot and the distal end.

14. The coupling member of claim 13 wherein the distal end includes external threads.

15. The coupling member of claim 11 wherein the proximate end includes a sleeve portion defining an internal circumferential surface and an external circumferential surface, the sleeve portion further defining a channel extending from the internal circumferential surface to the external circumferential surface, and the internal circumferential surface defines a seal receiving groove disposed axially between the channel and the bearing receiving slot.

16. The coupling member of claim 15 wherein the distal end includes a flange.

17. A linear roller bearing comprising:
a cylindrical body defining a cylindrical axis and a diameter;
wherein the cylindrical body defines cylindrical body axial length, and a ratio of the diameter to the cylindrical body axial length ranges from 0.75 to 1.1.

18. The linear roller bearing of claim 17 wherein the diameter ranges from 0.250 of inch to 0.750 of an inch.

19. The linear roller bearing of claim 18 wherein the cylindrical body axial length ranges from 0.225 of an inch to 1 inch.

20. The linear roller bearing of claim 17 wherein the cylindrical body is at least partially coated with tungsten carbide.
